(19) United States
(12) Patent Application Publication
(10) Pub. No.: US 2020/0232613 A1
(43) Pub. Date: Jul. 23, 2020

(54) ASSEMBLY FOR IMPROVED INSTALLATION AND METHOD OF USE

(71) Applicant: Lighting Solutions Group LLC, Columbus, OH (US)

(72) Inventors: Gerald Lauck, Columbus, OH (US); Ricky Nathans, Columbus, OH (US)

(21) Appl. No.: 16/742,997

(22) Filed: Jan. 15, 2020

Related U.S. Application Data
(60) Provisional application No. 62/795,656, filed on Jan. 23, 2019.

(51) Int. Cl. F21S 2/00; F21S 4/28; F21S 10/02

(52) U.S. Cl. CPC F21S 2/005; F21W 2131/109; F21S 10/02; F21S 4/28

(57) ABSTRACT

The invention is a lighting assembly that is primarily used in horticultural systems and method of using the same. The system comprises a lenticular array, a plurality of light emitting devices, a heat transfer system, a housing unit and a power supply. This system allows for the installation and use of light emitting devices in a horticultural system. Current systems use light emitting diodes (LEDs) but if the LEDs fans, the entire lighting module or system must be replaced. These systems are costly to build and ship. The current device, avows for the use and easy replacement of the faded parts of the system without requiring the user to purchase an entirely new module or the entire lighting assembly.

### CROSS-REFERENCE TO RELATED APPLICATIONS

This application claims the benefit of U.S. Provisional Application No. 62/795,656, filed Jan. 23, 2019, the disclosures of which are hereby incorporated by reference as if fully restated herein.

### BACKGROUND AND SUMMARY OF THE INVENTION

The current device is a lighting assembly that is primarily used in horticultural systems. This system allows for the installation and use of light emitting devices in a horticultural system. Current systems use light emitting diodes (LEDs) but if the LEDs fad, the entire lighting module or system must be replaced. These systems are costly to build and ship. The current device, allows for the use and easy replacement of the failed parts of the system without requiring the user to purchase an entirely new module. The configuration, ease of replacement, and cost savings on the current system are not and have not been contemplated by the prior art, as the industry believes it is not technologically or economically feasible to make LED lighting in this manner.

In addition to the novel features and advantages mentioned above, other benefits will be readily apparent from the following descriptions of the drawings and exemplary embodiments.

Horticulture lighting is known in the art. US Pat. App. No. 2010031562, for instance, describes a lighting installation for use in greenhouse farming for lighting crops in a greenhouse, comprising a number of light sources, such as lamps, provided above the crops to be lighted, and a number of dimmer devices for the light sources, characterized in that the dimmer devices are provided with control means for periodically, automatically varying the light intensity of the light sources cooperating with the dimmer devices according to a predetermined pattern.

US Pat. App. No. US2010031562 aims to provide a method and lighting installation, respectively, for greenhouse farming. In particular, the light sources are divided into a number of groups, the lighting installation being designed such that, in use, the power of each group varies according to a predetermined pattern, while patterns of different groups are phase-shifted relative to each other such that the electric power consumed by the joint groups varies less than the sum of the power variations of the separate groups, more particularly such that the electric power consumed by the joint groups varies less than the power variation of a single group, more particularly still such that the electric power consumed by the joint groups varies to a smallest possible extent, or does, at least virtually, not vary. In particular, all patterns are the same, but only phase-shifted relative to each other.

Various manufacturers make LED lighting systems for horticultural use. However, none of these commercially available systems disclose a system as herein disclosed in which the user can obtain the benefits of LED technology and be able to replace single key part(s) or key pieces of the system in an economical fashion which permits for the lighting system to have an extensively prolonged life.

### General Background

Plants use the process of photosynthesis to convert light, C0₂ and H₂0 into carbohydrates (sugars). These sugars are used to fuel metabolic processes. The excess of sugars is used for biomass formation. This biomass formation includes stem elongation, increase of leaf area, flowering, fruit formation, etc. The photoreceptor responsible for photosynthesis is chlorophyll.

Pant growth depends not only on the amount of light but also on spectral composition, duration, and timing of the light on the plant. A combination of parameter values in terms of these aspects is called “light recipe” for growing the plan (herein, the words plant and crop can be interchanged).

LEDs can play a variety of roles in horticultural lighting such as: 1. Supplemental lighting: Lighting that supplements the natural daylight is used in order to increase production (of tomatoes for example) or extend crop production during e.g. the autumn, winter, and spring period when crop prices may be higher; 2. Photoperiodic lighting: The daily duration of light is important for many plants. The ratio of the light and dark period in a 24-hour cycle influences the blossoming response of many plants. Manipulating this ratio by means of supplemental lighting enables regulating the time of blossoming; 3. Cultivation without daylight in plant factories; 4. Tissue culture.

For providing supplemental lighting during autumn, winter, and spring in green-houses (or all-year round in certain environments such as multi-layer growth), in general high-power gas-discharge lamps are used that have to be mounted at a relative high location above the plants to ensure sufficiently uniform light distribution across the plants. At present, in green houses different types of high power lamps ranging from 600 up to 1000 W (e.g. high power HID) are used to provide plants with supplemental light. One drawback is that from the location above the plants the amount of light reaching the lower parts of the plant may be rather limited, dependent upon the type of crop. At the same time, the lower parts of the plant are often most in need of supplemental light. The same dilemma persists when using solid state lighting that is mounted above the plants. Nevertheless, LED lighting, especially solid-state lighting, has some advantages over discharge-based lighting.

Yet despite these advantages, it is hard and expensive to replace burned out lights and burned out LED lighting panels.

When plants experience any sudden changes in the environment, this translates to a certain stress level inhibiting efficient photosynthesis. This also applies to sudden light stress which may occur every time when supplementary lighting is used. Light changes occur as well naturally when clear sky changes to overcast weather. It has been shown that light induced stress can produce photo inhibition. An excess of light is the most common stress related to plants, however, sudden light interruptions cause stress on the plants as well. This especially has been observed when the plant is flowering.

For example, in a greenhouse with supplementary lighting, artificial light sources will be turned on (or off or be dimmed) automatically (based on light sensors and certain algorithms) or manually, or according to a specific light recipe. When this happens, plants will suddenly receive more (or less) light and they have to adjust theft rate of photosynthesis and other processes accordingly to accommodate this sudden change. This kind of stress is even worse in an environment when the artificial light is the only light source, such as in a tissue culture room (or multi-layer horticulture production facility). Similar effect occurs with turning off the light.

Hence, it is an aspect of the invention to provide an alternative lighting system and/or an alternative horticulture production facility (such as a greenhouse or multi-layer system) including (and using) such alternative lighting system, which preferably further at least partly obviates one or more of the above-described drawbacks. It is especially the intention of this invention to reduce the plant stress generated by sudden changes in the artificial lighting or natural daylight by providing a lighting system that is easy to use, control, and replace key components of thus preventing a long term lapse of light to growing plants when needed.

Hence, in a first aspect, the invention provides a lighting system comprising (i) a lighting device comprising a plurality of light sources for application in a horticulture production facility comprising said lighting device, wherein the light sources are configured to illuminate with horticulture light crops within said horticulture production facility, wherein the lighting system further has a power supply, lens, and a light emitting device(s) that are easy and cheaper to replace than conventional systems.

In terms of greenhouses for high wire crop growth, often inter-lighting is used, i.e. supplemental lighting in between the crops or plants, to illuminate areas of the plant that are difficult to illuminate from the top using natural outdoor light and/or artificial light. In the case of inter-lighting the “local light receiving area” is the vertical area of the plants illuminated with the inter-lighting. This vertical area is especially the area of a plane with a height which is the mean height of the plants in the row in a specific plant row and a length which is the length of the plant row. Hence, this can be seen as a cross-sectional vertical planar area parallel to the row of the plants or crops.

Herein, the term “horticulture production facility” may refer to a greenhouse or a multi-layer production facility (or multi-layer plant factory). Such horticulture production facility may substantially apply daylight as light source and optionally supplemental light, as will in general be the case in greenhouses, or may substantially use artificial light as light source, as will in general be the case in multi-layer facilities. A greenhouse may thus be seen as a type of single-layer plant factory.

The invention may overcome the following problems or disadvantages: 1. Plants experience stress when an artificial light source burns out and is not immediately replaced; 2. In the presence of natural daylight in a greenhouse environment, plants experience different light settings as they are on the North or South or East or West side of the greenhouse (cardinal positions). Those light settings differences get higher when artificial light is controlled regardless of daylight changes in intensity; 3. Similarly, LED chips experience stress (e.g., thermal and mechanical stress) at the moment of large current changes, e.g., from 0 mA to 350 mA. The stress is considered to affect the lifetime of the LED chips (and maybe other electronics components as well), and therefore potentially shortens the lifetime of LED lamps or modules. Advantageously, the invention provides a lighting system as well as the use of a method to cope with sudden (large) interruptions of light to the crop, by providing multiple lighting modules that are designed to simultaneously light a single area and provide for a method to quickly and cheaply replace light sources which have died. The above-mentioned problem(s) may be solved with this lighting system as well as this use of a method, especially in combination with a light sensor and a (remote) controlled lighting system.

The term “horticulture” relates to (intensive) plant cultivation for human use and is very diverse in its activities, incorporating plants for food (fruits, vegetables, mushrooms, culinary herbs) and non-food crops (flowers, trees and shrubs, turf-grass, hops, grapes, medicinal herbs). The term “crop” is used herein to indicate the horticulture plant that is grown or was grown. Plants of the same kind grown on a large scale for food, clothing, etc., may be called crops. A crop is a non-animal species or variety that is grown to be harvested as e.g. food, livestock fodder, fuel, or for any other economic purpose. The term “crop” may also relate to a plurality of crops. Horticulture crops may especially refer to food crops (tomatoes, peppers, cucumbers and lettuce), as well as to plants (potentially) bearing such crops, such as a tomato plant, a pepper plant, a cucumber plant, etc. Horticulture may herein in general relate to e.g. crop and non-crop plants. Examples of crop plants are Rice, Wheat, Barley, Oats, Chickpea, Pea, Cowpea, Lentil, Green gram, Black gram, Soybean, Common bean, Moth bean, Linseed, Sesame, Khesari, Sunhemp, Chillies, Brinjal, Tomato, Cucumber, Okra, Peanut, Potato, Corn, Pearlmillet, Rye, Alfalfa, Radish, Cabbage, Lettuce, Pepper, Sunflower, Sugarbeet, Castor, Red clover, White clover, Safflower, Spinach, Onion, Garlic, Turnip, Squash, Muskmelon, Watermelon, Cucumber, Pumpkin, Kenai, Oilpalm, Carrot, Coconut, Papaya, Sugarcane, Coffee, Cocoa, Tea, Apple, Pears, Peaches, Cherries, Grapes, Almond, Strawberries, Pine apple, Banana, Cashew, Irish, Cassava, Taro, Rubber, Sorghum, Cotton, Triticale, Pigeonpea, and Tobacco. Especially of interest are tomato, cucumber, pepper, lettuce, water melon, papaya, apple, pear, peach, cherry, grape, and strawberry.

Horticulture crops may especially be grown in a greenhouse, which is an example of a horticulture production facility (or horticulture factory). Hence, the invention especially relates to the application of the lighting system and/or the (use of the) method in a greenhouse or other horticulture production facility. The lighting device, or more especially the plurality of light sources, may be arranged between plants, or between plants to be, which is referred to as “inter-lighting”. Horticulture growth on wires, like tomato plants, may be a specific field of application for inter-lighting, which application may be addressed with the present device and method. The lighting device, or more especially the plurality of light sources, may also be arranged over the plants or plants to be. Combinations of configurations of light sources, such as in between the crops (inter-lighting) and over the crops, may also be applied. Hence, in embodiments the light sources are configured over the crops, or between the crops, or over and between the crops.

Especially when horticulture crops are grown in layers on top of each other, artificial lighting is necessary. Growing horticulture crops in layers is indicated as “multilayer growth” and may take place in a (multi-layer growth) horticulture production facility. Also in multi-layer growth horticulture production facility, the lighting system and/or method may be applied.

In some exemplary embodiments, such horticulture application comprises a plurality of said lighting devices, wherein said lighting devices are optionally configured to illuminate crops substantially horizontally within said horticulture production facility (such as by inter-lighting). In another exemplary embodiment, the horticulture production facility comprises multiple layers for multi-layer crop growth, the horticulture application further comprising a plurality of said lighting devices, configured for lighting the crops in said plurality of layers.

The term “horizontal” in relation to the Illumination refers to a (substantial horizontal arrangement of the optical axis of the illumination beam generated by the light source or lighting device). The term “horizontal” ay refer to “substantially horizontal”, with slight deviations, like within 10°, especially within 5°, such as within 1°, from the earth's surface.

In case of a multi-layer system, this may relate to the area of a multi-layer. Light from optional other light sources, including the sun, may also be included. Hence, total light received by the plants can be seen as the sum of all photons that are generated and received per second, divided by the local light receiving area of the horticulture production facility.

The horticulture production facility may be divided in different locations (or areas). For instance, each light source, or a subset of light sources, is especially configured to provide lighting in a specific location (of the horticulture production facility or horticulture factory). The term “location” is used to indicate part of the area that is used to grow the horticulture crops. Further, the horticulture production facility, especially a greenhouse, may comprise locations that receive more daylight than others, or are subject to less or more daylight changes than others. It is for instance referred to the cardinal positions of locations within the horticulture production facility. Dependent upon for instance predetermined settings and/or the presence of a plurality of sensors, a plurality of locations may be defined. However, this does not exclude the definition of the whole interior of the horticulture production facility as a single location, though in general it may be desirable to define a plurality of locations to be able to locally prevent stress of plants. In such instances, it may be desirable to control the intensity (and optionally spectral light distribution; see also below), of the light at such location i.e. the local light. As will be clear to the person skilled in the art upon review of this application, the local light is the sum of the horticulture light and light at the location originating from an optional other light source, such as the sun.

As indicated above, it is desirable that the light intensity does not fluctuate too much (in short time periods). A very short fluctuation (with a return to the original level) may not be observed by the plants and may thus not lead to stress. Further, fluctuations on a large time scale may be adaptable for the plant. However, fluctuations with a substantial increase or reduction in light intensity (and/or spectral light distribution) may lead to plant stress.

It may also not be desirable to have a substantial change in spectral light distribution. Hence, with the lighting device allowing the spectral light distribution of the horticulture light to be tunable, the control unit may also be configured to prevent a substantial change in the spectral light distribution of the local light at the location over the predetermined period of time, as defined herein, by controlling the contribution of horticulture light to the local light. By tuning the spectral light distribution of the horticulture light from the light sources, locally a spectral light distribution change, if considered too substantial, may be compensated.

Further, it may especially be desirable to locally measure the light intensity of the local light, and optionally also the spectral light distribution of the local light. Hence, in an embodiment, the lighting system further comprises a sensor (especially optical sensor), configured to sense the amount of the local light at the location. The term “sensor” may also refer to a plurality of sensors. Especially, the horticulture production facility comprises a plurality of such light sensors. Each light sensor may be used to sense the light intensity of the local light, and optionally also the spectral light distribution of the local light, at a specific location. Or, in other words, the number of sensors may determine the number of locations.

Further, in some exemplary embodiments, the control unit is further configured to control one or more of the intensity and the spectral light distribution of the local light at the location as a function of a predetermined light recipe by controlling the contribution of the horticulture light to the local light. Hence, the control unit may impose a light scheme or recipe and impose this in such a way, that each change occurs gradually.

In a further aspect, the invention also provides a lighting device (or luminaire) that may e.g. be applied in this method. The term “lighting device” may also refer to a plurality of lighting devices, which may all be controlled with the same control unit (see further below). In a further aspect, the invention provides a lighting device comprising a plurality of light sources, especially arranged in 2D array of light sources. In specific exemplary embodiments, the lighting device may be based on an open grid or mesh of LEDs with connecting wires, wherein the grid or mesh of LEDs defines a grid plane, and wherein especially the LEDs are configured to provide horticulture light in beams of light having optical axes perpendicular to the grid plane (see further also below). The orientation of the LEDs may, in embodiments, alternate between sending light from a front, or first side, and from a back, or second side, of the grid plane. Hence, subsets (or LED arrangements) of the total number of LEDs may be configured anti-parallel with respect to each other (see further also below). Note that front and back can—dependent upon the configuration—be interchanged. Further, in some exemplary embodiments, the LEDs may be grouped such that the driving voltage may be kept constant irrespective the size of the LED grid. In some exemplary embodiments, the LEDs in the grid may emit different colors of light. AH LEDs emitting a certain color may be arranged in a sub-grid (subset) and sub-grids may be interweaved to maximize illumination uniformity. In some exemplary embodiments, the LEDs and current wires are covered with a transparent plastic or foil e.g. sandwiched between two sheets of plastic with holes at appropriate locations corresponding with openings in the grid.

Next to the fact that the lighting devices, or more especially the light sources, may be configured to be located in between the (future) crops, the lighting device may also be applied as a top lighting device for multi-layer growth. This concept may thus be applied in inter-lighting but also in other types of lighting, such as top lighting, including multi-layer lighting (see below). Hence, the invention is not limited to inter-lighting applications.

The lighting device, especially the grid, may span an area of for instance as little as 0.5 ft² to as much as 400 m² or more depending on the number of lighting assemblies used. The number of light sources, especially LEDs, per m² (LED density) may for instance be in the order of 0.2-400, such as 4-100, though there may be grids with more or even with less light sources, especially LEDs, per square meter. Note that the distribution of the light sources, especially LEDs, over the lighting device, such as e.g. a grid, may be regular or may vary in different areas in the grid. In general, the light sources, especially LEDs will be arranged in a regular pattern, though other patterns may not be excluded. The device may comprise for instance at least 16 light sources, especially LEDs. In some embodiments, the device comprises n×m LEDs, wherein n is at least 1, and m is at least 1. The size, number, and luminosity of the LEDs will be determined by those of skill in the art at the time of design and for each specific use case.

In some exemplary embodiments, the light sources, especially LEDs, are configured to provide light in one direction, e.g. light emanating from one side of a lighting device, such as a grid-based lighting device. This may for instance be of interest for top lighting. In other embodiments, the light sources, especially LEDs, are configured to provide light in two substantially opposite directions, e.g. light emanating from two sides of a lighting device, such as a grid-based lighting device.

The LEDs that are used in some exemplary embodiments are especially solid state LEDs, but may optionally also be organic LEDs. Also, combinations of solid state and organic LEDs may be applied. The term “LED” may also relate to a plurality of LEDs. Hence, in embodiments, at a single LED position a plurality of LEDs may be arranged, such as an LED package of 2 or more LEDs. The term “LED” may also relate to an LED package.

The advent of solid state lighting based on LEDs offers opportunities for application in horticulture. The main advantages of using LEDs result from the possibility to control the spectral composition of the light to closely match the plant's photoreceptors' sensitivity. Together with additional benefits like improved heat control and freedom of distributing the LEDs across the horticulture application area, this provides a more optimal production and enables influencing the plant's morphology and composition. It also promises a reduced energy consumption (and associated cost).

Solid state LEDs are easily integrated into digital control systems, facilitating lighting programs such as “daily light integral” lighting and sunrise and sunset simulations. LEDs are safer to operate than current lamps because they do not have glass envelopes and do not contain mercury.

LEDs enable one to distribute the light closer to the target which can result in less loss through the roof and into the floor of the greenhouse. Moreover, a better light distribution across the crop can be accomplished. This is certainly the case for high-wire crops like tomatoes.

One or more LEDs may comprise converter material(s), such as one or more of an inorganic dye and an organic dye, for at least partially converting the LED light into light having another wavelength.

The lighting device may be a flexible lighting device. For instance, it may be a flexible (2D) wire grid or a flexible mesh. The lighting device may suspend from a roof or ceiling or may be provided in a frame (such as between rails that may also be used as or include electrical conductors), etc. (see also above).

In some exemplary embodiments, the plurality of light sources, especially light emitting diodes, comprise two or more independently controllable subsets of light emitting diodes. The two or more subsets are independently controllable, such as by the control unit (see also below). In this way, the on-off status, and optionally the intensity and/or optionally the color, of the two or more subsets may individually be controlled. The light sources, especially LEDs may be arranged in and/or on a (conductive) wire grid. In some exemplary embodiments, the first subset comprises a plurality of light sources, especially light emitting diodes. In other exemplary embodiments, the second subset comprises a plurality of light sources, especially light emitting diodes. In yet another exemplary embodiment, the first subset comprises a plurality of light sources, especially light emitting diodes, and the second subset comprises a plurality of light sources, especially light emitting diodes. The invention also relates in some exemplary embodiments to a method and/or device wherein the plurality of light sources, especially light emitting diodes, comprises two or more independently controllable subsets of light sources, especially light emitting diodes, wherein at least two of said subsets are configured to generate light having different spectral distributions. Different subsets of the plurality of light sources, especially LEDs, may provide different types of light such that the spectral distribution may be tuned to the needs of the horticulture processes.

In preferred exemplary embodiments, the light sources used herein are especially configured to provide at least light in the range of 400-475 nm and 625-800 nm, especially 625-730 nm, such as 625-700 nm.

Hence, to be able to locally vary the light intensity and/or spectral light distribution, it is especially desirable in some exemplary embodiments that the lighting systems comprise a plurality of lighting devices and/or a plurality of light sources, which are independently controllable. Controllable herein may especially refer to the controllability of the light intensity and/or the spectral light distribution, respectively.

In a further aspect, as also indicated above, the invention in some embodiments also provides a horticulture production facility comprising a lighting system, the lighting system comprising (i) a lighting device comprising a plurality of light sources configured within the horticulture production facility, and configured to illuminate with horticulture light crops within said horticulture production facility, wherein the lighting system further comprises (ii) a control unit which is configured to control the light intensity of local light at a location within the horticulture production facility, wherein the local light is the sum of the horticulture light and light at the location originating from an optional other light source, and wherein the control unit is configured to prevent a change in the amount of the local light at the location within the horticulture production facility.

Further, any embodiment of the lighting system described herein may be used in the horticulture production facility.

With e.g. exemplary embodiments of the lighting system of the invention, the light intensity and optionally also the spectral light distribution can be imposed to change only gradually. Hence, in a further aspect, the invention also provides the use of a method of providing horticulture light to a crop in a horticulture production facility comprising providing said horticulture light to said crop, wherein when the light intensity of the horticulture light is changed, this change only occurs by gradually increasing or decreasing with time. Especially, such use may also take into account the presence of light originating from other optional (external) light sources, such as the sun. Hence, in further specific embodiments the method further includes adapting the light intensity of the horticulture light to one or more of (a) the light intensity of additional light irradiating the crop originating from an optional other light source, (b) a horticulture light recipe and (c) the cardinal position of a light source providing said horticulture light. As indicated above, this may be used for reducing stress in the crop. In a specific embodiment, the invention allows to anticipate the cloud coverage and compensate for that in advance, based on a feed forward loop.

Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

The devices or apparatus herein are amongst others described during operation. As will be clear to the person skilled in the art, the invention is not limited to methods of operation or devices in operation.

An exemplary embodiment of a lighting system of the present invention comprises a modular light for horticulture application comprising a plurality of LED lighting units wherein each lighting unit comprises one or more power wires for receiving power from a power source, a heat sink, a circuit board removably affixed to the heat sink wherein the circuit board comprises at least one LED that is wired to receive power from the power wires, a means for selectively receiving the power wires wherein the power wire receiving means is affixed to the circuit board such that the circuit board can be connected and disconnected from the power wires and the heat sink for easy replacement. The power wire receiving means may be an electrical connector. A preferred exemplary embodiment of a modular light comprises four modular lighting units.

A preferred exemplary lighting system for use in a horticultural facility includes at least one power supply, a circuit board upon which a plurality of light emitting devices (i.e. LEDs) are disposed in a predetermined geometric pattern. At least one electrical connection port is included upon the circuit board to enable a selective electrical connection of the plurality of light emitting devices to the power supply. The exemplary lighting system additionally comprises at least one lenticular array comprising at least one lens designed to diffuse the light produced by at least some of the light emitting devices. A heat transfer system that is positioned in proximity to the light emitting devices to pull heat from and out of the lighting system is also included in the exemplary embodiment. The exemplary system comprises a housing unit with a plurality of attachment devices wherein the housing unit contains or is attached to the circuit board, the power supply, the heat transfer system, and the at least one lenticular array wherein the plurality of attachment devices are designed to hold the circuit board, power supply input and lenticular array in a desired order and place wherein the means of connecting the circuit board and lenticular array to the housing unit is such that if one or more of the light emitting devices fails, the circuit board can be replaced without replacing the entire lighting system.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “to comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

The invention further applies to an apparatus or device comprising one or more of the characterizing features described in the description and/or shown in the attached drawings. The invention further pertains to a method or process comprising one or more of the characterizing features described in the description and/or shown in the attached drawings.

The various aspects discussed in this patent can be combined in order to provide additional advantages. Furthermore, some of the features can form the basis for one or more divisional applications.

### BRIEF DESCRIPTION OF THE DRAWINGS

FIG. 1A shows a perspective view of the electrical connectors.

FIG. 1B shows a different perspective view of the electrical connectors.

FIG. 1C shows a top view of the electrical connectors.

FIG. 1D shows a back view of the electrical connectors.

FIG. 1E shows a side view of the electrical connectors.

FIG. 1F shows a front view of the electrical connectors.

FIG. 1G shows a bottom view of the electrical connectors.

FIG. 2A shows a perspective view of the different electrical connectors.

FIG. 2B shows a different perspective view of the different electrical connectors.

FIG. 2C shows a top view of the different electrical connectors.

FIG. 2D shows a back view of the different electrical connectors.

FIG. 2E shows a side view of the different electrical connectors.

FIG. 2F shows a front view of the different electrical connectors.

FIG. 2G shows a bottom view of the different electrical connectors.

FIG. 3 shows a perspective view of an exemplary lighting system of the present invention.

FIG. 4 shows a different perspective view of the exemplary lighting system shown in FIG. 3.

FIG. 5 shows a side view of the exemplary lighting system shown in FIG. 3.

FIG. 6 shows a top view of the exemplary lighting system shown in FIG. 3.

FIG. 7 shows a bottom view of the exemplary lighting system shown in FIG. 3.

FIG. 8 shows one side view of the exemplary lighting system shown in FIG. 3.

FIG. 9 shows a second side view of the exemplary lighting system shown in FIG. 3.

FIG. 10 shows a perspective view of the exemplary lighting system shown in FIG. 3 shown with the lenticular array removed.

FIG. 11 shows a perspective view of an exemplary single module of the lighting system with the lenticular array removed and a single electrical connection.

FIG. 12A shows a close-up view of the electrical connector and wires of the exemplary single module shown in FIG. 11.

FIG. 12B shows a close-up view of the electrical wires connected to the electrical connector of the exemplary single module shown in FIG. 11.

FIG. 13 shows an exploded perspective view of the exemplary single module shown in FIG. 11 with each component of the module removed to show the entire assembly.

FIG. 14 shows a perspective view of a second exemplary embodiment of a single module of the lighting system wherein said exemplary module has dual electrical connections and is shown with the lenticular array removed.

FIG. 15A shows a close-up view the electrical connector and wires of the exemplary module shown in FIG. 14.

FIG. 15B shows a close-up view of the electrical connector and wires of the exemplary module shown in FIG. 14 wherein the electrical wires are shown connected to the electrical connector.

FIG. 16 shows an exploded perspective view of the exemplary single module of the lighting system shown in FIG. 14 with each of the components of the module removed to show the entire assembly.

FIG. 17 is a perspective view of a second exemplary embodiment of a modular lighting system.

FIG. 18 is a different perspective view of the second embodiment of the lighting system shown in FIG. 17.

FIG. 19A is a perspective view of a lighting module of the FIG. 17 exemplary embodiment shown having a single electrical connection at the end of the module.

FIG. 19B is a perspective view of a lighting module of the FIG. 17 exemplary embodiment shown having dual electrical connections.

### DETAILED DESCRIPTION OF EXEMPLARY EMBODIMENT(S)

Some exemplary embodiments of the present invention are directed towards the use of the device described herein. The lighting assembly is for use in a horticultural industry or facility in preferred exemplary embodiments.

Any embodiment of the present invention may include any of the optional or preferred features of the other embodiments of the present invention. The exemplary embodiments herein disclosed are not intended to be exhaustive or to unnecessarily limit the scope of the invention. The exemplary embodiments were chosen and described in order to explain some of the principles of the present invention so that others skilled in the art may practice the invention. Having shown and described exemplary embodiments of the present invention, those skilled in the art will realize that many variations and modifications may be made to the described invention. Many of those variations and modifications will provide the same result and fall within the spirit of the claimed invention. It is the intention, therefore, to limit the invention only as indicated by the scope of the claims.

Turning now to the figures, the various exemplary embodiments of the invention will be described in particular.

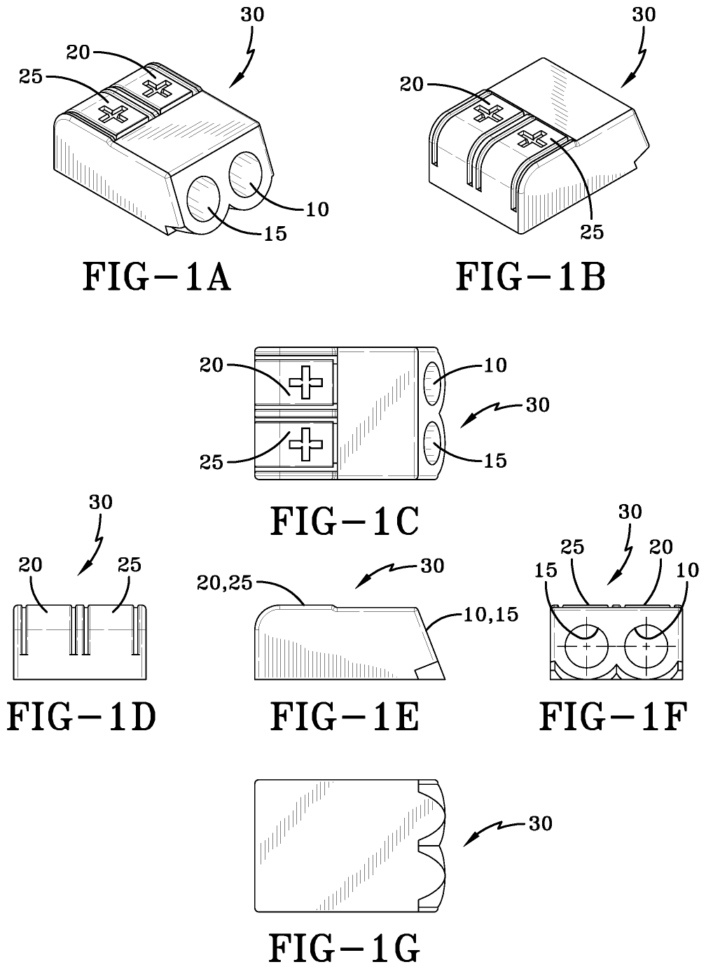

FIGS. 1A-1G show various views of one type of electrical connector, 30 that can be used in the lighting system. As shown in FIG. 1A, there are two wire connection ports, 10 and 15, that can be used to selectively hold electrical wires and securing devices, 20 and 25, to selectively hold the wires in place.

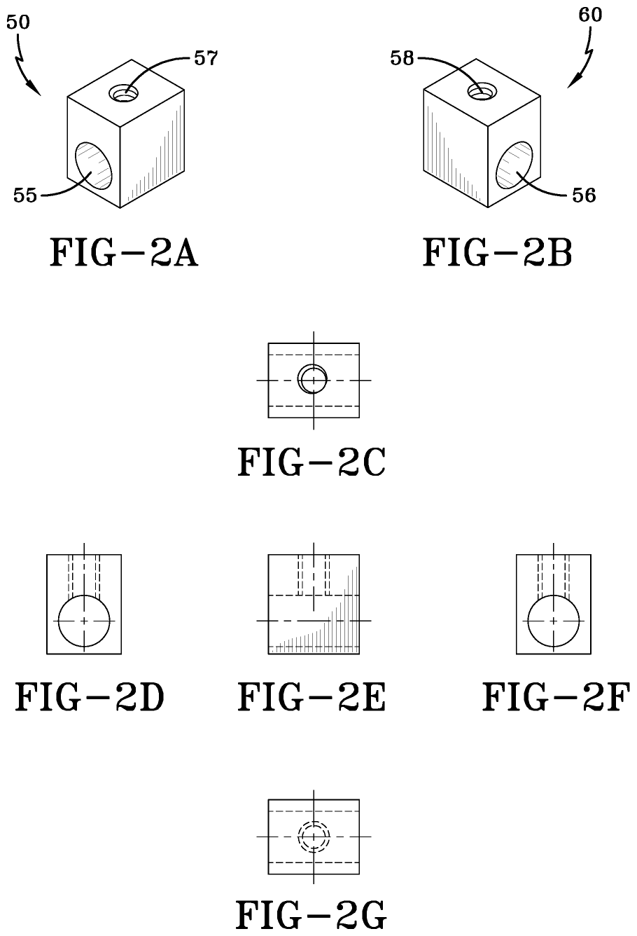

FIGS. 2A-2G show various views of a second type of electrical connectors, 50 and 60. In this exemplary embodiment, each connector, 50 and 60, has a single connection port, 55 and 56, respectively. These connection ports, 55 and 56, will each have one wire placed in them, either a positive or ground wire, but not both in one port, in order to provide power to the light emitting devices. Additionally, each connector, 50 and 60, has a set screw hole, 57 and 58, in which to place a set screw to hold the wires in place. The connectors 50 and 60, may be used to selectively hold electrical wires in exemplary embodiments of the lighting system being disclosed herein.

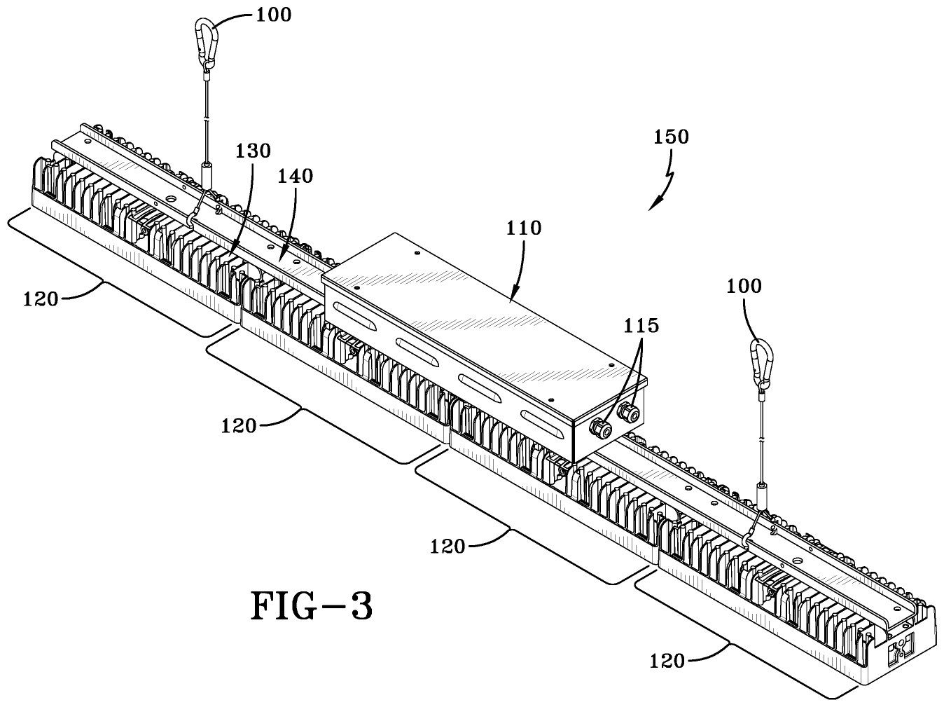

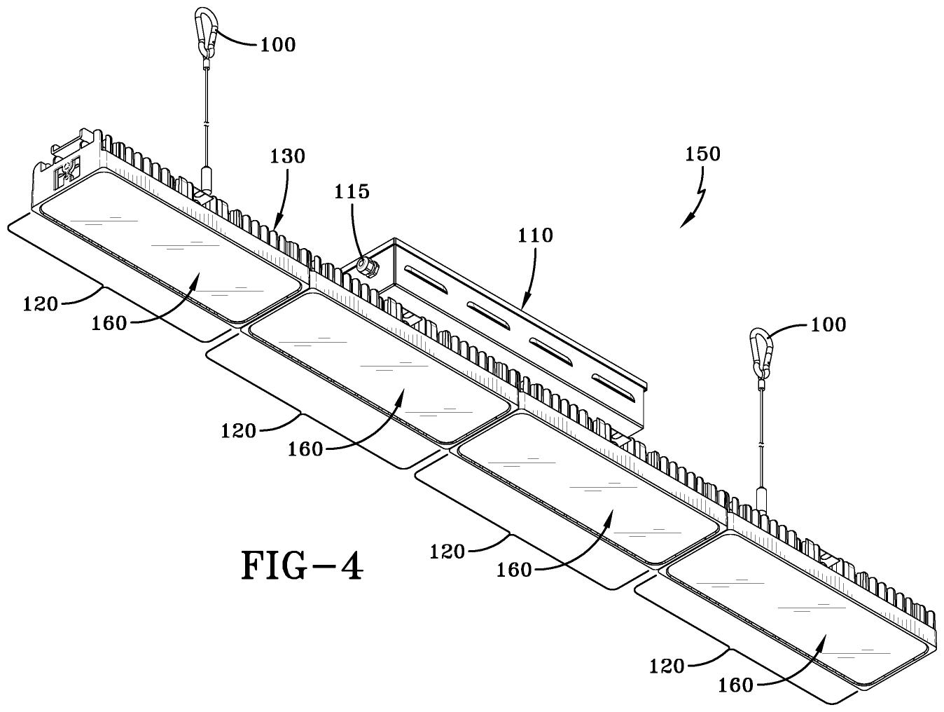

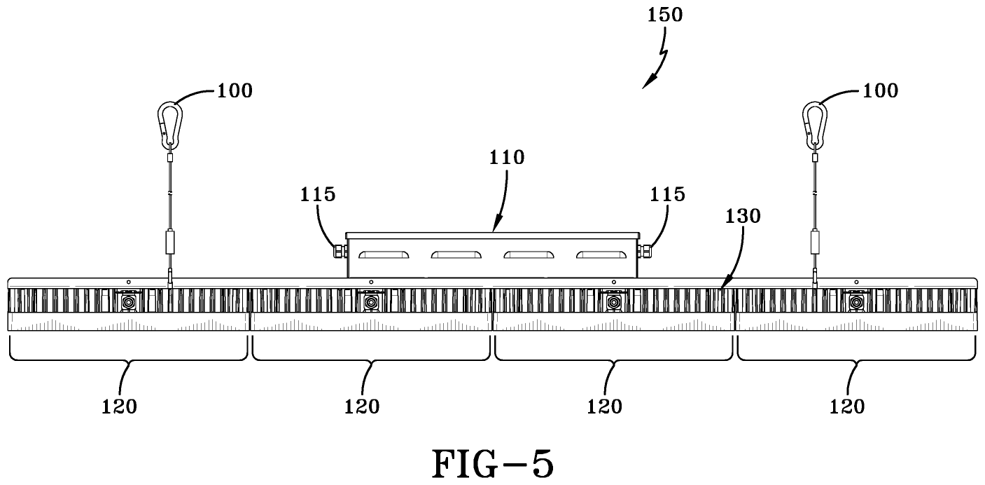

FIGS. 3 and 4 show a top and bottom, respectively, perspective view of an exemplary lighting assembly, 150. The power supply, 110, has connections, 115, that allow it to draw power from an external source if needed. In some exemplary embodiments, the power supply, 110, also has the space and capacity for a battery backup should external power fail.

The exemplary lighting assembly shown in FIG. 3, has a support system, 100, that allows the lighting assembly, 150, to be hung from an overhead location. Alternatively, the lighting assembly, 150, has a connector rail, 140, that can be used, along with additional supports, not shown, to connect the lighting assembly 150 to a vertical post or wall. The exemplary embodiment shown in FIG. 3 includes more than one lighting module 120 (as shown four modules are included), wherein each module 120 has a set of fins, 130, which act as a convection heat sink to remove the heat produced by the lighting elements. Finally, FIG. 4 shows how each lighting module, 120, has a lens, 160, protecting the light emitting devices and diffusing light from them over a wider area.

As shown in FIG. 5, the exemplary embodiment shown in FIG. 3, has a generally rectangular profile having a length that is substantially greater than its height. As shown in this embodiment, the length of the lighting assembly 150 is equal to the length of four individual lighting modules 120. In different exemplary embodiments, a greater or lesser number of lighting modules can be utilized. In some exemplary embodiments, a fewer number of lighting modules can be used without altering the length of the lighting assembly 150. In some exemplary embodiments, there must be at least two lighting modules 120 that form the length of the lighting assembly 150.

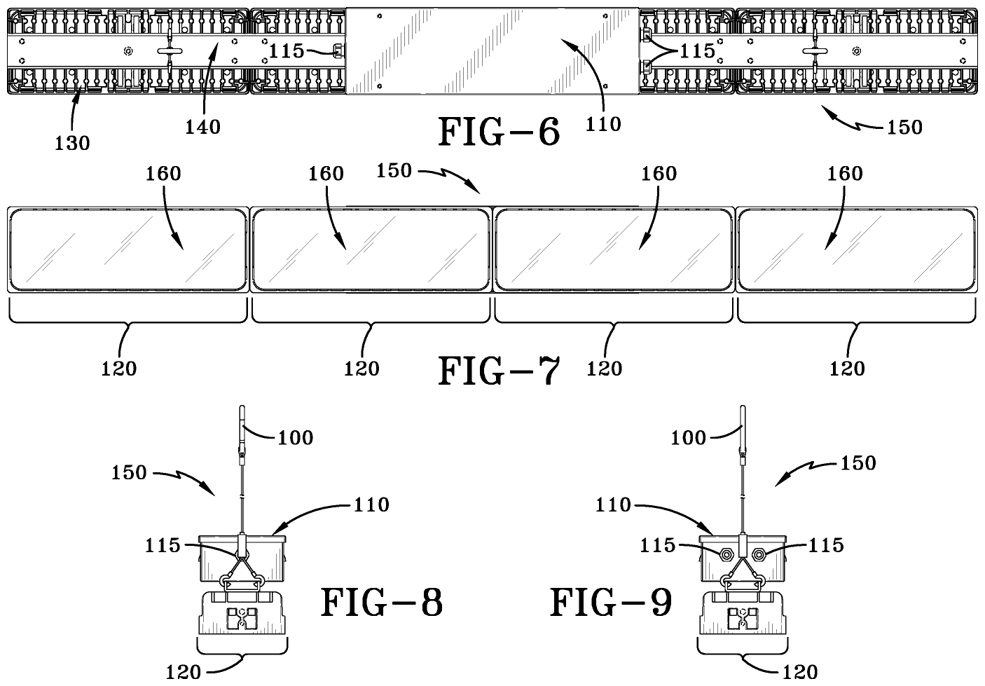

As can be seen in FIG. 6, in the exemplary embodiment shown in FIG. 3, the power source 110 is generally rectangular in shape and has a width that is substantially equal to the width of a lighting module. FIG. 7, shows the bottom perspective view of an exemplary lighting assembly 150 and its plurality of lighting modules 120 each of which comprises a lens 160.

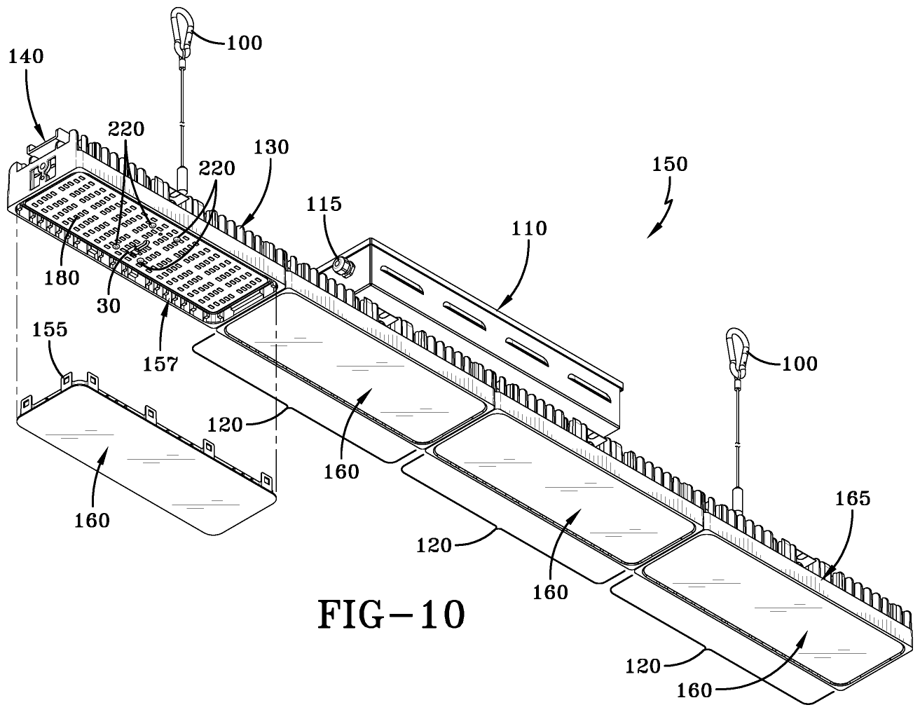

As can be seen in FIGS. 8 and 9, the exemplary support system 100 that may be used to hang the lighting system 150 in some embodiments may be substantially perpendicular to the width of the lighting module 120.

FIG. 10 shows a bottom up perspective view of the exemplary lighting assembly 150 shown with one of the lenses, 160, removed from one of the individual lighting modules 120. The exemplary lens, 160, as shown in FIG. 10, has square holes, 155, attached to the sides of the lens, 160. The exemplary individual lighting modules, 120, each has a housing unit, 165, that has hooks, 157, on the inside wall of the housing unit 165. The hooks, 157, engaged with the square holes, 155, on the lens, 160, to hold the lens, 160, in place. Further, the light emitting devices, 180, and electrical connector, 30, can be seen.

The housing unit, 165, can be made of single, or multiple materials. It is desirable that the housing unit be thermally conductive. To accomplish this the housing unit 165 should preferably be made of material(s) that have a thermal conductivity of at least 1 Watt/(meter-Kelvin). In exemplary embodiments that produce a large amount of heat a thermal conductivity of at least 100 Watts/(meter-Kelvin) is desirable. Such materials include, but are not limited, too, aluminum, copper, gold, iron, lead, silver, tungsten, some oxides of these metals, and some composites.

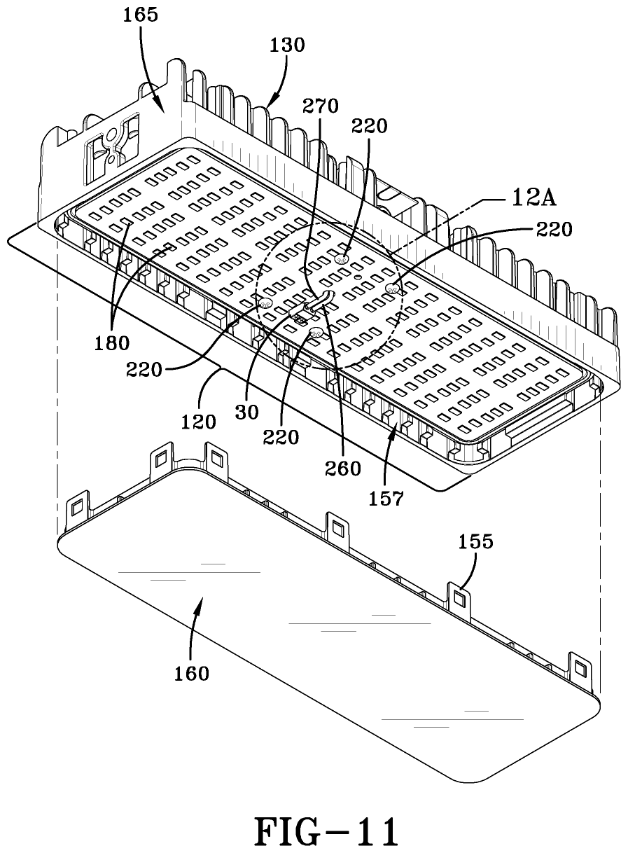

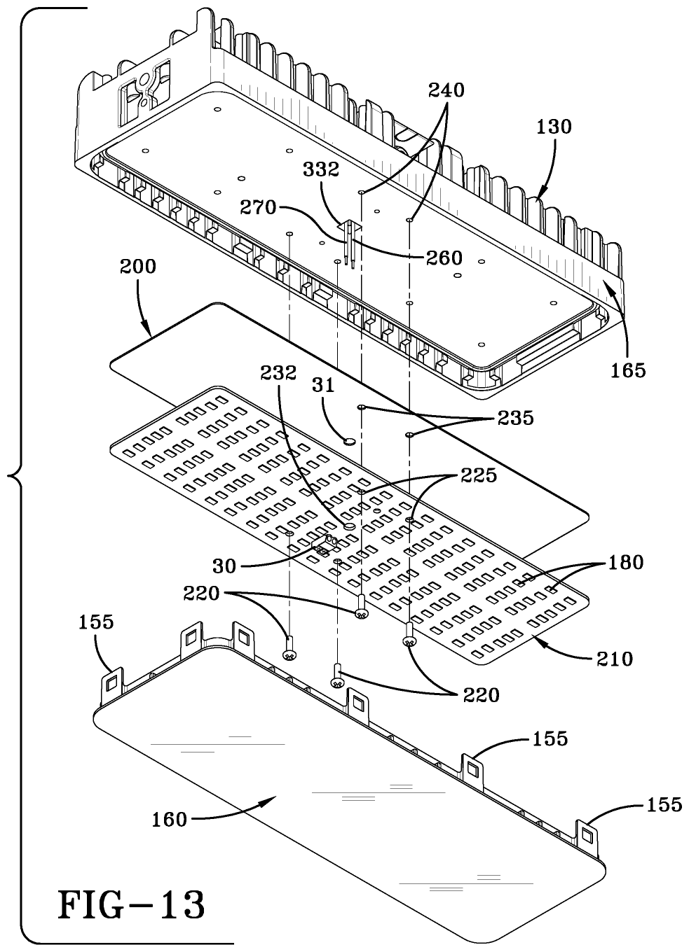

FIGS. 11 and 13 show various views of the exemplary individual lighting modules, 120. As shown in FIG. 11, the lens, 160, has been selectively separated from the lighting module, 120. FIGS. 11 and 13 show a closer view of the exemplary single lighting module 120. FIG. 13 further shows the method of assembly of the exemplary lighting module, 120. The first component of the exemplary lighting module 120 is the housing unit, 165, which contains a plurality of fins 130 which act as a heat sink. Further the housing unit, 165, has a central hole 332 that allows electrically conductive wires, 260 and 270, to pass through it. Finally, the exemplary housing unit 165 has a plurality of screw holes, 240, that allow the various pieces of the lighting module to be held in place by the screws 220. In other exemplary embodiments adhesives, bolts, and other mechanical means can be used to hold these components in place.

FIG. 13 shows that a heat dissipation plate, 200, which is optional, can be inserted into the module 120. This heat dissipation plate, 200, has screw holes, 235, for the screws 220 to pass through and a hole, 31, for the electrically conductive wires to pass through.

FIG. 13 next shows a circuit board, 210, with a plurality of light emitting devices, 180. As previously discussed, the light emitting devices may be solid state LEDs, but may optionally also be organic LEDs. Further other light emitting devices may be used if desired. The light emitting devices, 180, are shown in FIG. 13 in a rectangular geometric pattern, however there is no limitation that this is the only or optimal pattern. Those of skill in the art will be able to design an optimal pattern of light emitting devices based on the crops being grown and the amount of light needed.

The circuit board, 210, as shown in FIG. 13 has an electrical connection device, 30, that will connect to the wires, 260 and 270, and provide power to the light emitting devices, 180. A hole, 232, in the circuit board 210 allows the wires 260 and 270 to pass through the circuit board and selectively engage with the electrical connector 30. Finally, screws, 220, are shown that go through screw holes, 225, and pass through the screw hole, 235, in the heat dissipation plate, 200, and engage with the threads in the screw holes, 240, located in the housing unit, 165, to selectively hold all the parts in place, against and/or within the housing unit 165. The housing unit 165 is not required to have walls or screw holes as those of skill in the art will be able to determine the optimal means of holding all the parts to the lighting module in place, including other mechanical and chemical means. Finally, the lens, 160, is selectively attached to the housing unit, 165, with the square holes, 155.

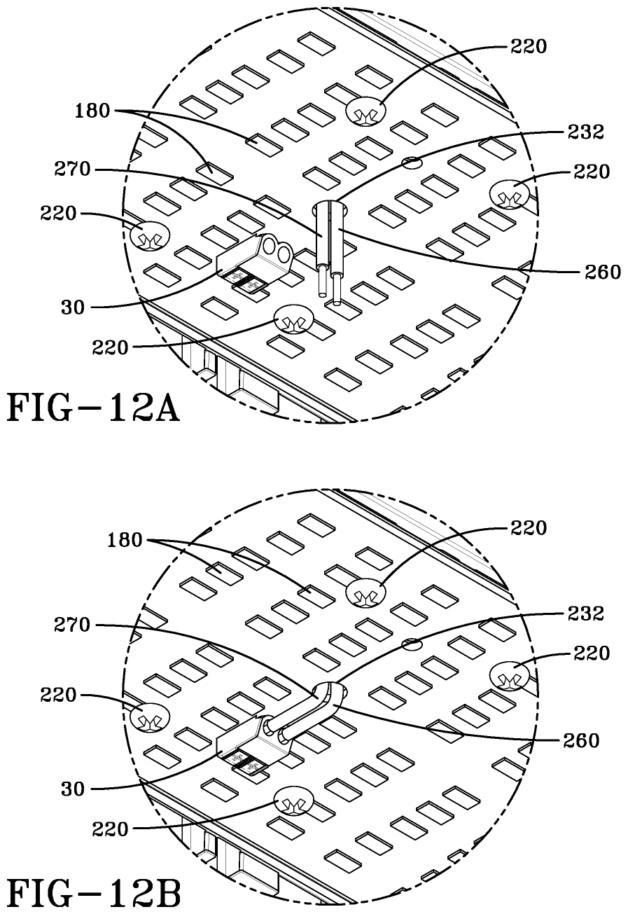

FIGS. 12A and 12B are close up views of how the wires are connected to the electrical connector, 30. As shown in FIG. 12A, the wires, 260 and 270, extend through the hole, 232, and have the potential to engage with the electrical connector 30. FIG. 12B shows the wires, 270 and 260, selectively engaged with the electrical connector 30.

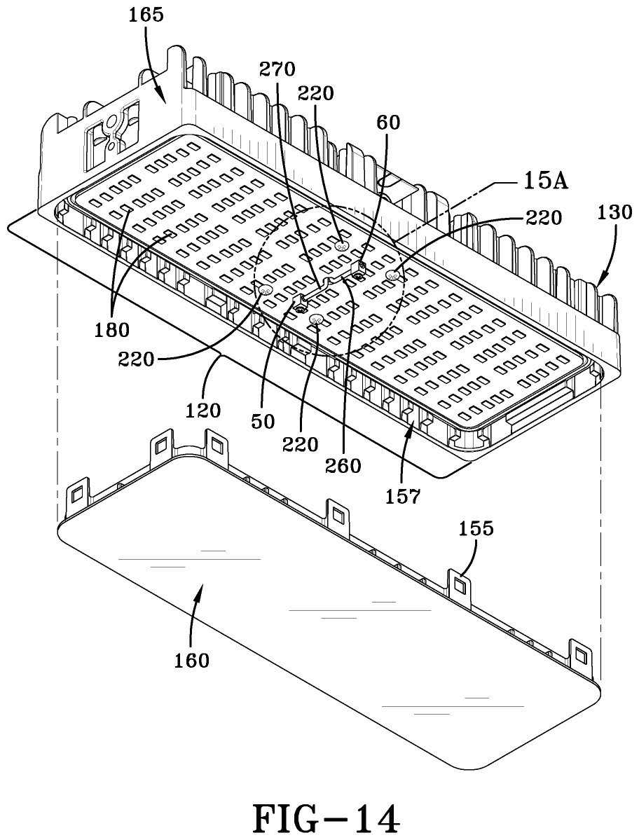

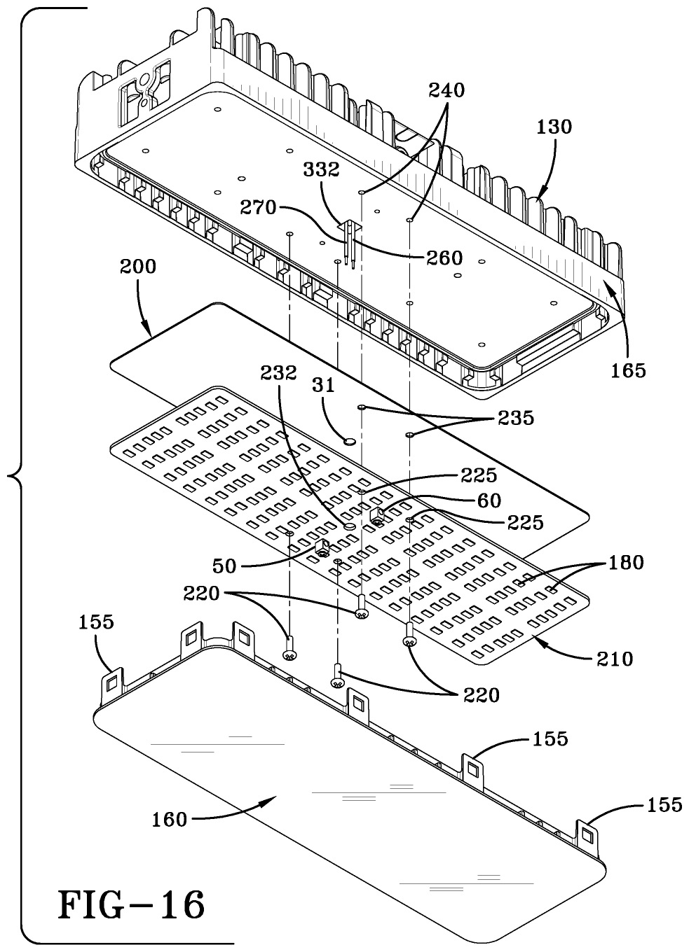

FIGS. 14 and 16 show various views of a second exemplary lighting module 1201. As shown in FIG. 14, the lens, 160, has been selectively separated from the lighting module, 1201. FIGS. 14 and 16 show a closer view of the second exemplary lighting module. FIG. 16 further shows the method of assembly of the second exemplary lighting module, 1201. The first component of the lighting modules 1201 is the housing unit, 165, which contains a plurality of fins 130 which act as a convention heat sink when the light is in use. Further the housing unit, 165, has a central hole 332 that allows electrically conductive wires, 260 and 270, to pass through it. Finally, the housing unit 165 has a plurality of screw holes, 240, that allow the various pieces of the lighting module to be selectively held in place. In other exemplary embodiments adhesives, screws, bolts, and other mechanical means can be used to hold these components in place.

FIG. 16 shows that a heat dissipation plate, 200, which is optional, can be inserted into the module 1201. This heat dissipation plate, 200, has screw holes, 235, and a hole, 31, for the electrically conductive wires 260 and 270 to pass through.

FIG. 16 next shows a circuit board, 210, with a plurality of light emitting devices, 180. As previously discussed, the lights emitting devices 180 may be solid state LEDs, but may optionally also be organic LEDs. Further other light emitting devices may be used if desired. In some exemplary embodiments, only LEDs may be utilized. The light emitting devices, 180, are shown in FIG. 16 in a rectangular geometric pattern, however there is no limitation that this is the only or optimal pattern. Those of skill in the art will be able to design an optimal pattern of light emitting devices based on the crops being grown and the amount of light needed.

The circuit board, 210, as shown in FIG. 16 has a set of electrical connection devices, 50 and 60, that will selectively connect to the wires, 260 and 270, and provide power to the light emitting devices, 180. A hole, 232, in the circuit board 210 allows the wires 260 and 270 to pass through the circuit board 210 and selectively engage with the electrical connectors, 50 and 60. Finally, screws, 220, are shown that go through screw holes, 225, and pass through the screw hole, 235, in the heat dissipation plate, 200, and engage with the threads in the screw holes, 240, located in the housing unit, 165, to selectively hold all the parts in place, against and/or within the housing unit 165. The housing unit 165 is not required to have walls or screw holes as those of skill in the art will be able to determine the optimal means of holding all the parts to the lighting module in place, including other mechanical and chemical means. Finally, the lens, 162, is attached to the housing unit, 165, with the square holes, 155.

The configuration of preferred exemplary embodiments, including those using one or more of the exemplary modules 120 or 1201 are such that the housing unit, 165, of a lighting module can be selectively opened, the wires, 260 and 270, disengaged from the electrical connectors,(i.e. 50 and 60 and/or 30), so that the circuit board, 210, and correspondingly the light emitting devices, 180 of a module, can be removed and replaced without replacing the entire module, other modules, or the entire lighting device/system 150.

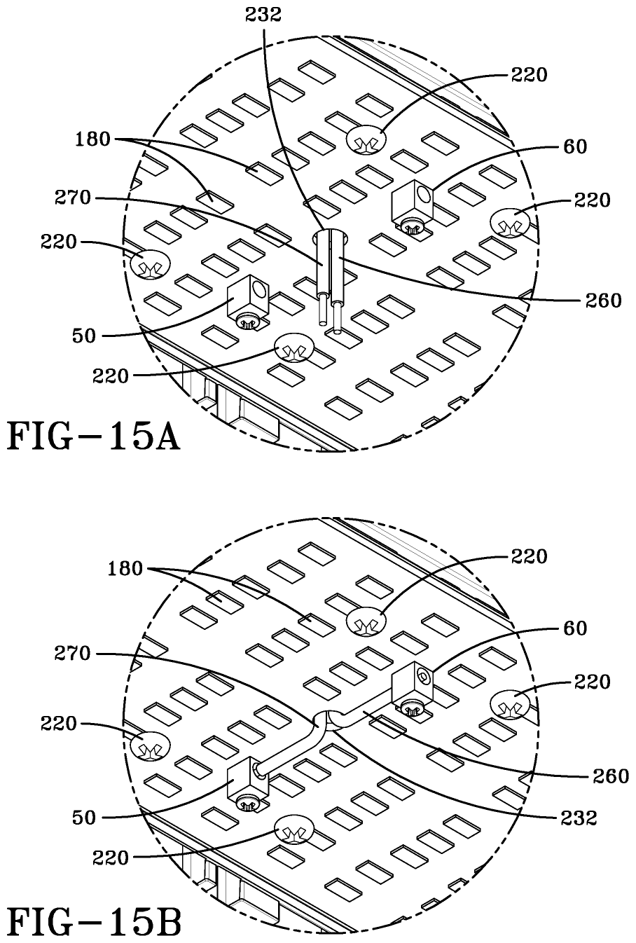

FIGS. 15A and 15B are close up views of how the wires are connected to the electrical connectors, 50 and 60 in exemplary module 1201. As shown in FIG. 15A wires, 260 and 270, extend through the hole, 232, and have the potential to selectively engage with the electrical connectors, 50 and 60. Each connector, 50 or 60, can connect to only one wire with each wire being either a positive or ground wire. FIG. 15B shows the wires, 270 and 260, selectively engaged with the electrical connectors, 50 and 60.

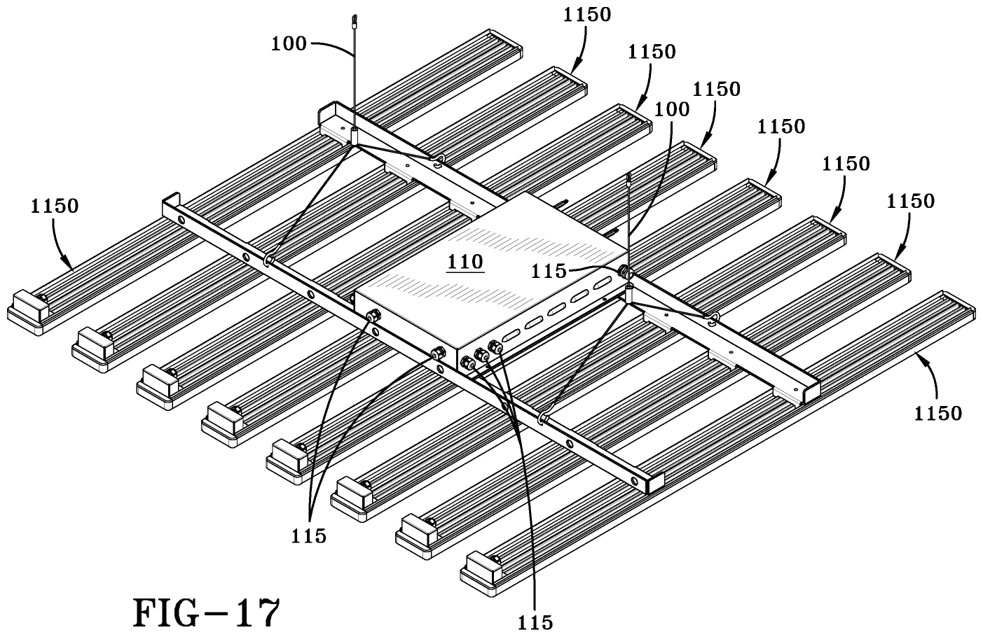

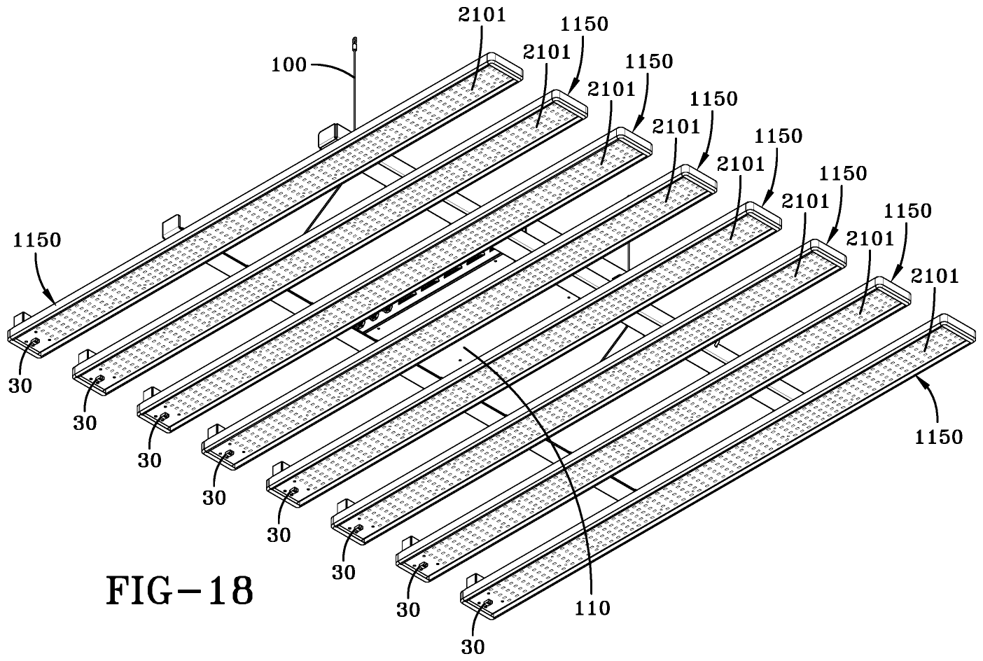

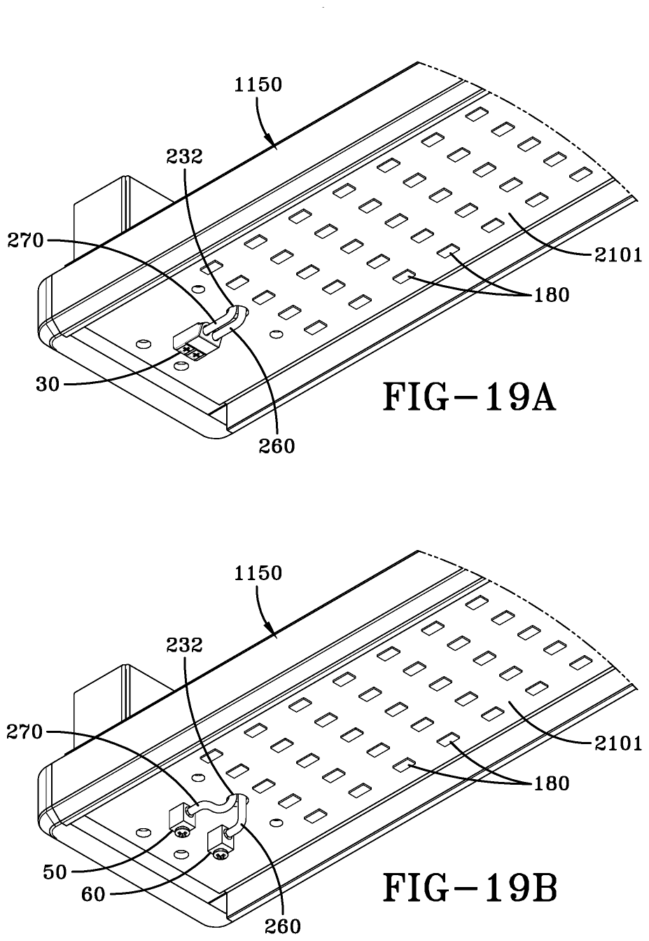

The exemplary embodiments shown in FIGS. 3 through 16 show that individual lighting modules can be connected to each other to create a light assembly 150 having a generally rectangular profile wherein the length of the profile is approximately equal to the combined lengths of the individual lighting modules 120. But, in some exemplary embodiments, such as those shown in FIGS. 17 and 18, the assemblies comprise one or more lighting modules 1150 wherein the entire length of the assembly is approximately equal to the length of each individual lighting module 1150. As shown in FIGS. 17 and 18, numerous individual lighting modules 1150 are in electronic connectivity with the power supply 110. FIG. 18, shows the circuit boards 2101 of each of the lighting modules 1150 wherein each of the circuit boards 2101 contains a plurality of LEDs, and a connector 30. The module 1150 would include at least one wire (not shown in FIGS. 17 and 18) which would pass through one or more holes 232 in the circuit board so as to be selectively received by connector 30. The circuit boards 2101 would be selectively received by the modules 1150 so that they could be quickly removed and replaced as/if needed without having to replace the entire module/light fixture. FIG. 18 does not show a lens as part of the module 1150 but upon reading the disclosure contained herein it should be understood by one of ordinary skill that such a lens could be selectively received by the module 1150 in the same or similar fashion as the lenses 160 discussed in conjunction with the embodiments shown in FIGS. 3 through 11.

The exemplary embodiment shown in FIGS. 12 and 13 utilize electrical connector 30. A close-up of this electrical connector, 30, is shown in FIG. 19A. But, different electrical connectors may be utilized. As shown in FIG. 19B, some exemplary embodiments of module 1150 may utilize electrical connectors 50 and 60.

As shown in FIGS. 19A and 19B the electrical connectors (i.e. 50 and 60 or and/or 30) may be disposed at the edge of a lighting module.

FIGS. 17 and 18, respectively, show a top and bottom perspective view of a large lighting assembly comprised of multiple lighting modules. As discussed above, the individual lighting modules 1150 shown in this exemplary embodiment have a length that is approximately equal to the overall length of the lighting assembly. While the exemplary embodiment shown in FIGS. 17 and 18 includes eight modules 1150, it should be appreciated by one of ordinary skill in the art upon reading this disclosure that a greater or lesser number of modules 1150 may be utilized by the assembly. But, some preferred exemplary embodiments have at least two modules.

In some exemplary embodiments, each of the individual modules 1150 of the exemplary embodiment shown in FIGS. 12 and 13 may be replaced by a light assembly 150 comprising more than one module 120 as shown in FIGS. 3 through 16. But, such an embodiment could utilize a single power source 110 in electronic connectivity with each of the light assemblies 150 (in other words each light assembly 150 would not include its own power source 110). This embodiment would allow the users to power multiple lighting assemblies 150 from a single power source while covering a wider area of plants with light.

What is claimed is:

1. A lighting system for use in a horticultural facility comprising:
at least one power supply;
a circuit board upon which is disposed a plurality of light emitting devices in a predetermined geometric pattern and at least one electrical connection port to electrically connect the plurality of light emitting devices to a power supply;
at least one lenticular array comprising at least one lens designed to diffuse the light produced by at least some of the light emitting devices;
a heat transfer system;
a housing unit with a plurality of attachment devices wherein the housing unit contains or is attached to the circuit board, the power supply, the heat transfer system, and the at least one lenticular array wherein the plurality of attachment devices are designed to hold the circuit board, power supply input and lenticular array in a desired order and place wherein the means of connecting the circuit board and lenticular array to the housing unit is such that if one or more of the light emitting devices fails, it can be replaced without replacing the entire lighting system.

2. The lighting system of claim 1 wherein the housing unit is designed to connect to at least one other housing unit.

3. The lighting system of claim 1 wherein the heat transfer system is a convection system.

4. The lighting system of claim 1 further comprising a heat transfer plate placed against the circuit board to facilitate the transfer of heat to the heat transfer system.

5. The lighting system of claim 1 wherein the one or more failed light emitting device(s) can be replaced by replacing the circuit board.

6. The lighting system of claim 1 wherein the light emitting devices are solid state or organic light emitting diodes.

7. The lighting system of claim 1 wherein one power supply can provide power to multiple circuit boards contained in multiple housing units.

8. The lighting system of claim 1 wherein the housing unit is made of a heat conductive material having a thermal conductivity of at least 1 W/(m-° K).

9. The lighting system of claim 8 wherein the housing unit is made of a thermally conductive material having a thermal conductivity of least 100 W/(m-° K).

10. The lighting system of claim 1 further comprising a pair of wires in electronic connectivity with the power supply and received by the housing such that the wires may be selectively received by the circuit board and the electrical connection port disposed thereon to provide power to the light emitting devices when the circuit board is held in its desired place within the housing.

11. A lighting system for use in a horticultural facility comprising:
at least one power supply:
at least one lighting module comprising:
a circuit board comprising a plurality of light emitting devices in a predetermined geometric pattern and at least one electrical connection port to electrically connect the plurality of light emitting devices to the power supply;
at least one lenticular array comprising at least one lens designed to diffuse the light produced by at least some of the light emitting devices;
a heat transfer system; and
a housing unit with a plurality of attachment devices wherein the housing unit contains or is attached to the circuit board, the heat transfer system, and the least one lenticular array wherein the plurality of attachment devices are designed to hold the circuit board and lenticular array in a desired order and place wherein the means of connecting the circuit board and lenticular array to the housing unit is such that if one or more of the light emitting devices fails, the circuit board can be replaced without replacing the entire module.

12. The lighting system of claim 11 wherein the system comprises at least two lighting modules in electrical connectivity with the power source.

13. The lighting system of claim 12 wherein the light emitting devices are color changing light emitting diodes.

14. The lighting system of claim 12 wherein the light emitting devices are light emitting diodes.

15. The lighting system of claim 11 further comprising a pair of wires in electronic connectivity with the power supply and received by the housing of at least one module such that the wires may be selectively received by the circuit board of the module and the electrical connection port disposed thereon to provide power to the light emitting devices when the circuit board is held in its desired place within the module's housing.

16. A method for using a lighting system for application in a horticultural production facility comprising:
at least one lighting module comprising:
at least one power supply;
a circuit board comprising a plurality of light emitting devices in a predetermined geometric pattern and at least one electrical connection port to electrically connect the plurality of light emitting devices to a power supply;
at least one lenticular array comprising at least one lens designed to diffuse the light produced by the light emitting device;
a heat transfer system;
a housing unit with a plurality of attachment devices wherein the housing unit contains or is attached to the circuit board, the power supply, the heat transfer system, and the least one lenticular array wherein the plurality of attachment devices are designed to hold the circuit board, power supply input and lenticular array in a desired order and place wherein the means of connecting the circuit board and lenticular array to the housing unit is such that if the light emitting device fails, it can be replaced without replacing the entire lighting system; and
placing at least one of the lighting systems in close proximity to at least one plant or other agricultural product to provide light to the plant.

17. The method of using a lighting system for application in a horticultural production facility of claim 16 wherein the housing unit is designed to connect to at least one other housing unit.

18. The method of using a lighting system for application in a horticultural production facility of claim 16 wherein the heat transfer system is a convection system.

19. The method of using a lighting system for application in a horticultural production facility of claim 16 further comprising a heat transfer plate placed against the circuit board to facility the transfer of heat to the heat transfer system.
